(19) United States
(12) Patent Application Publication
(10) Pub. No.: US 2014/0015949 A1
(43) Pub. Date: Jan. 16, 2014

(54) INFORMATION PROCESSING APPARATUS, INFORMATION PROCESSING METHOD, AND INFORMATION PROCESSING PROGRAM

(71) Applicant: SONY CORPORATION, Tokyo (JP)

(72) Inventors: Yutaka Hasegawa, Tokyo (JP); Kouji Ogura, Kanagawa (JP); Masato Kajimoto, Chiba (JP); Masashi Kimoto, Tokyo (JP); Yoichi Mizutani, Saitama (JP)

(73) Assignee: SONY CORPORATION, Tokyo (JP)

(21) Appl. No.: 13/910,496

(22) Filed: Jun. 5, 2013

(30) Foreign Application Priority Data
Jul. 13, 2012 (JP) 2012-157241

(51) Int. Cl. G06F 3/0485

(52) U.S. Cl. CPC G06F 3/0485
USPC 348/77; 348/79

(57) ABSTRACT

Provided is an information processing apparatus, including: an obtaining section configured to obtain a pathological image; a display unit configured to display at least a portion of the obtained pathological image as partial display area; an input unit configured to receive an instruction to move the partial display area from a user; a recording section configured to periodically record at least position information of the partial display area in the pathological image as display history, the position information being in relation with display time; and a reproduction section configured to reproduce movement of the partial display area in the pathological image based on the pathological image and the display history.

### BACKGROUND

The present disclosure relates to an information processing apparatus configured to control a displayed image, which is obtained by a microscope, in the fields of medicine, pathology, biology, materials, and the like.

The present disclosure further relates to an information processing method and an information processing program.

In the field of medicine or pathology, the following system is proposed. That is, an optical microscope obtains an image of cells, tissues, an organ, and the like of a living body. The image is digitalized. A doctor, a pathologist, or the like examines the tissues or the like or makes a diagnosis of a patient based on the digital image.

For example, according to a method of Japanese Patent Application Laid-open No. 2009-37250, a microscope optically obtains an image. A video camera including a CCD (Charge Coupled Device) digitalizes the image. The digital signal is input in a control computer system. The digital signal is visualized on a monitor. A pathologist watches the image displayed on the monitor, and examines the image, for example (for example, see Japanese Patent Application Laid-open No. 2009-37250, paragraphs [0027] and [0028], and FIG. 5).

Further, a technology of recording observation history of a pathological image is disclosed (for example, Japanese Patent Application Laid-open No. 2011-112523). The present technology provides a means for preventing a pathologist from passing over a portion to be observed in a pathological image.

### SUMMARY

In general, the larger the observation magnification, the smaller the observation area of a microscope with respect to the entire area of an observation target. For example, in most cases, a pathologist observes an observation target by using a microscope while the microscope scans the entire area of the observation target. The pathologist observes a portion of the entire area at a particularly higher magnification, to thereby examine the observation target. Lets' say that there is disease in an area of the observation target, which the pathologist does not watch, in such examination. In other words, the pathologist passes over the disease. This situation may cause a serious problem afterward.

In view of the above-mentioned circumstances, it is desirable to provide an information processing apparatus, an information processing method, and an information processing program capable of eliminating the risk of passing over an observation target by a user when he uses a microscope.

It is further desirable to provide an information processing apparatus, an information processing method, and an information processing program capable of protecting personal information of a pathological image as an observation target.

It is further desirable to provide an information processing apparatus, an information processing method, and an information processing program useful for education in the field of the observation target.

(1) According to an embodiment of the present technology, there is provided an information processing apparatus, including: an obtaining section configured to obtain a pathological image; a display unit configured to display at least a portion of the obtained pathological image as partial display area; an input unit configured to receive an instruction to move the partial display area from a user; a recording section configured to periodically record at least position information of the partial display area in the pathological image as display history, the position information being in relation with display time; and a reproduction section configured to reproduce movement of the partial display area in the pathological image based on the pathological image and the display history.

According to the present technology, first, a pathologist as a user obtains a pathological image to be observed from a server. A display unit displays a portion of the pathological image in a partial display area. Then, the user moves the partial display area in the pathological image. As a result, the display unit displays another portion of the pathological image. The user observes this portion. The recording section records at least position information (coordinate and magnification) of an image displayed in the partial display area when the user observes the pathological image, as display history. The position information is in relation with display time. The reproduction section is capable of reproducing observation history of a pathological image based on the display history and based on the observed pathological image. The user is capable of confirming which portion of the pathological image is displayed and observed. As a result, it is possible to eliminate the risk of passing over an observation target by a user when he uses a microscope.

(2) According to another embodiment of the present technology, the reproduction section may be configured to reproduce the movement of the partial display area in the pathological image based on time corresponding to actual time.

Let's say that, for example, display history indicates that a user observes a pathological image for one hour. According to this configuration, in this case, it takes one hour to reproduce the display history. As a result, it is possible to accurately reproduce allocation of time when a user observed a pathological image. As a result, another user may experience a feeling of observation.

(3) According to another embodiment of the present technology, the information processing apparatus may further include a detection section configured to detect presence of a user, the user observing a pathological image. The recording section may be configured to periodically record at least position information of the partial display area in the pathological image as display history while the detection section keeps on detecting the presence of the user, the position information being in relation with display time.

According to this configuration, the recording section records display history only when a user certainly observes a pathological image. Let's say that, for example, a user leaves his desk while a pathological image is still displayed. In this case, the recording section does not record display history. The recording section records display history only when a user certainly observes a pathological image. As a result, it is possible to increase of accuracy of display history.

(4) According to another embodiment of the present technology, the detection section may include a camera configured to take a picture of the face of the user, and a face detection section configured to detect if the camera takes a picture of the face or not. The recording section may be configured to periodically record at least position information of the partial display area in the pathological image as display history while the face detection section keeps on detecting the face, the position information being in relation with display time.

According to this configuration, a camera and a face detection algorithm detect a user, who observes a pathological image. Because of this, it is possible to record display history when a user certainly watches a pathological image. As a result, it is possible to increase accuracy of display history more.

(5) According to another embodiment of the present technology, the recording section may be further configured to record, if a display time period of a specific area exceeds a preset time period, an image of the specific area, the specific area being in an area displayed as the partial display area.

According to this configuration, let's say that a user observes a portion of a pathological image for a time period longer than a preset time period. In this case, it is highly likely that this portion is important.

Because of this, a snapshot of this portion is taken in addition to recording of display history. As a result, it is possible to observe the image of the important portion, even if display history is not reproduced.

(6) According to another embodiment of the present technology, the information processing apparatus may further include a producing section configured to produce images to be superimposed on all the pixel sites of the displayed partial display area, respectively, at a predetermined time cycle, each of the to-be-superimposed images having a value corresponding to a display time period of the partial display area, to cumulatively superimpose the to-be-superimposed images on the pathological image, and to produce a composite result as a path image, the path image showing a movement path of an area displayed as the partial display area.

According to this configuration, a movement path of a partial display area on a pathological image is not directly recorded on a pathological image. Alternatively, each pixel value of a to-be-superimposed image, which is to be superimposed on the pathological image, is adjusted, whereby the movement path is recorded on the pathological image. The pixel value is, for example, a value showing transparency of a pixel. A unicolor image is prepared as a to-be-superimposed image, which is to be superimposed on a pathological image. Transparency of the to-be-superimposed image is changed depending on a time period of displaying the partial display area. As a result, it is possible to display a pathological image as if a path of a portion displayed in the partial display area is recorded on the pathological image. Positions and time as a movement path of a partial display area are recorded on a path image. The path image is a composite image including a pathological image and an image superimposed on the pathological image (to-be-superimposed image). Because of this, by watching the path image, a user may understand a time period, for which he observed a specific portion. As a result, it is possible to eliminate the risk of passing over a pathological image.

(7) According to another embodiment of the present technology, there is provided an information processing method, including: obtaining, by an obtaining section, a pathological image; displaying, by a display unit, at least a portion of the obtained pathological image as partial display area; receiving, by an input unit, an instruction to move the partial display area from a user; periodically recording, by a recording section, at least position information of the partial display area in the pathological image as display history, the position information being in relation with display time; and reproducing, by a reproduction section, movement of the partial display area in the pathological image based on the pathological image and the display history.

(8) According to another embodiment of the present technology, there is provided an information processing program, causing a computer to function as: an obtaining section configured to obtain a pathological image; a display unit configured to display at least a portion of the obtained pathological image as partial display area; an input unit configured to receive an instruction to move the partial display area from a user; a recording section configured to periodically record at least position information of the partial display area in the pathological image as display history, the position information being in relation with display time; and a reproduction section configured to reproduce movement of the partial display area in the pathological image based on the pathological image and the display history.

As described above, according to the present technology, it is possible to eliminate the risk of passing over an observation target by a user when he uses a microscope.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a typical usage environment of a viewer computer 500 of the present technology;

FIG. 2 is a block diagram showing the hardware configuration of the viewer computer 500 of the present technology;

FIG. 3 is a diagram showing the functional blocks of an image management server 400;

FIG. 4 is a diagram showing the functional blocks of the viewer computer 500;

FIG. 5 is a diagram showing an example of a viewer window;

FIG. 6 is a diagram showing an example of a display record/reproduction GUI;

FIG. 7 is a sequence diagram for explaining the recording/reproducing flow of window display history in response to viewer operations, and the processing flow when a user leaves his desk;

FIG. 8 is a diagram showing an example of the format of display history;

FIG. 9 is a diagram showing a composite path image, in which a display path is superimposed on an entire pathological image;

FIG. 10 is a diagram showing that an entire pathological image A and a mask image B are different images, and that the mask image B is superimposed on the pathological image A;

FIG. 11 shows graphs each showing how an alpha value is increased;

FIG. 12 is a graph showing how the increase amount of an alpha value is changed in a case where a specific portion is observed for a long time period;

FIG. 13 is a flowchart for explaining a processing flow of producing a path image;

FIG. 14 is a diagram showing a process that a user browses a shot image of a sample SPL displayed in an observation area 62;

FIG. 15 is a diagram showing an example in which the process that the user browses the shot image of the sample SPL displayed in the observation area 62 is recorded as a display path; and

FIG. 16 is a flowchart for explaining the relation of the functions of the present technology in the overall processing flow.

### DETAILED DESCRIPTION OF EMBODIMENTS

Hereinafter, an embodiment of the present disclosure will be described with reference to the drawings.

### First Embodiment

### Usage Environment of Viewer Computer

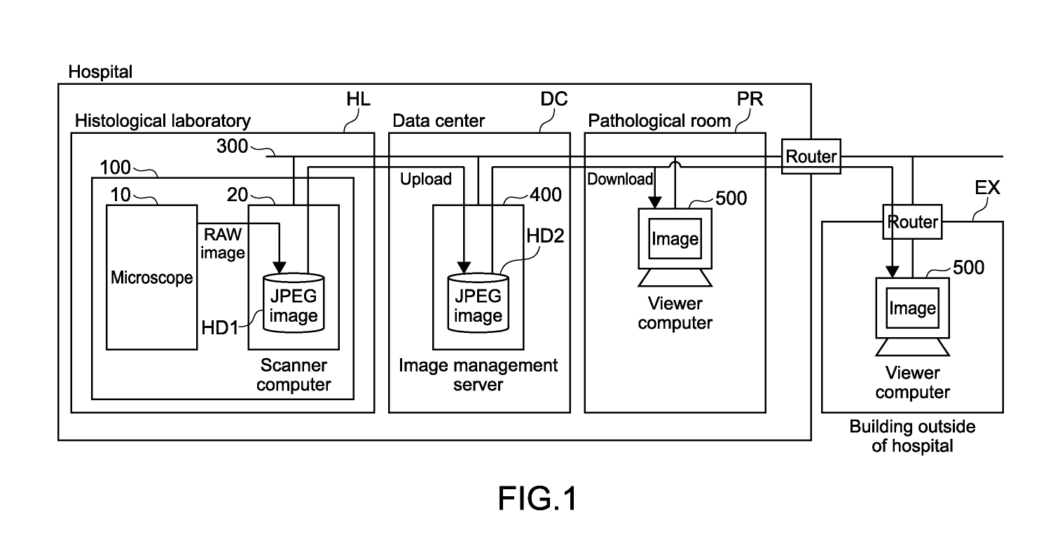

First, the whole picture of an environment of pathology, in which a pathologist makes a diagnosis by using a virtual slide image (pathological image), will be described. The virtual slide image (pathological image) is obtained by taking a picture of a specimen by using a microscope. A pathologist uses a viewer of a viewer computer, observes a pathological image, and makes a diagnosis by using the image. FIG. 1 is a diagram showing a typical usage environment of a viewer computer 500 of the present technology.

A scanner 100 includes a microscope 10 and a scanner computer 20. The scanner 100 is installed in a histological laboratory HL in a hospital. The microscope 10 takes a RAW image. The scanner computer 20 processes the RAW image. Examples of the image processing include processing procedure, shading processing, color balance correction, gamma correction, and 8-bit processing. After that, the processed image is divided into tiles. The size of the tiles is 256 pixels×256 pixels. The image divided into tiles is converted into a JPEG (Joint Photographic Experts Group) image, and is compressed. After that, the compressed image is stored in a hard disk HD1.

The hard disk HD1 of the scanner computer 20 stores the JPEG image. Next, the JPEG image is uploaded to a hard disk HD2 via a network 300. The hard disk HD2 is in an image management server 400. The image management server 400 is in a data center DC in the same hospital.

A pathologist as an observer is in a pathological room PR in the hospital or in a building EX outside of the hospital. The pathologist observes a JPEG image stored in the hard disk HD2 of the image management server 400 by using the viewer computer 500. The viewer computer 500 is connected to the image management server 400 via the network 300.

Alternatively, a pathologist as an observer instructs the viewer computer 500 to record display history. The display history shows how a JPEG image displayed on a viewer window changes based on an operation, which is input by the pathologist when he observes the JPEG image. The recorded display history is sent to the image management server 400 via the network 300. The image management server 400 stores the display history.

Further, a pathologist instructs the viewer computer 500 to call up the display history, which is stored in the image management server 400, and to reproduce, on the viewer, how a pathologist observed a JPEG image.

[Outline of the Present Technology]

Next, the outline of the present technology will be described. In the past, an image of a path of observing a pathological image by using the viewer computer 500 was overlapped with a pathological image and was recorded. However, it is desirable to accurately reproduce the display status on a window when a pathologist performs image diagnosis. In view of this, according to the present technology, an image of a viewer window is “recorded” as display history when a pathologist performs image diagnosis. After that, the “recorded image” is reproduced as if it is a moving image. As a result, a display status on a window is reproduced accurately.

Because data is recorded in this manner, it is possible to verify if an observer passed over a portion of a pathological image or not afterward. Further, it is possible to prove that an observer watched a pathological image afterward. Further, because how a pathologist observed an image is reproduced accurately, the data may be an educational material useful for education for pathologists.

Further, according to the present technology, a camera detects that a pathologist, who observes a pathological image, watches the viewer certainly. As a result, it is possible to increase accuracy of “image recording” and recording of other data.

[Configuration of Viewer Computer 500]

Next, the hardware configuration of the viewer computer 500 will be described.

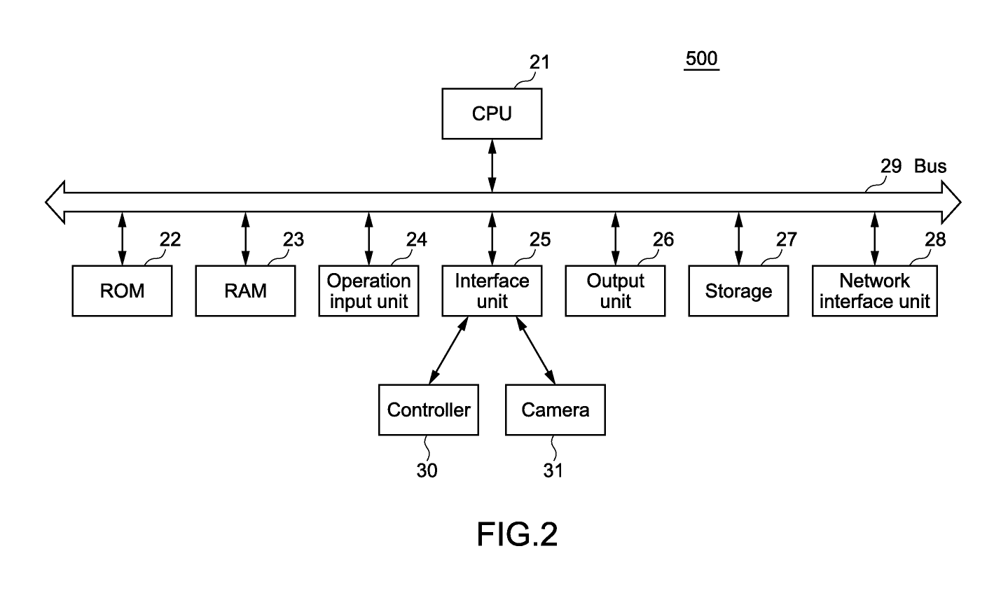

FIG. 2 is a block diagram showing the hardware configuration of the viewer computer 500 of the present technology.

The viewer computer 500 includes a CPU (Central Processing Unit) 21, a ROM (Read Only Memory) 22, a RAM (Random Access Memory) 23, and an operation input unit 24 (input unit). The CPU 21 performs arithmetic control. The RAM 23 is a work memory for the CPU 21. Instructions depending on operation by a user are input in the operation input unit 24. The viewer computer 500 further includes an interface unit 25, an output unit 26 (display unit), storage 27, a network interface unit 28, and a bus 29 connecting them.

Programs for executing various processes are stored in the ROM 22. A controller 30 and a camera 31 (detection section) is connected to the interface unit 25. The controller 30 includes various buttons and sticks. The controller 30 is configured to receive various kinds of input from a user. Further, the controller 30 includes a built-in acceleration sensor and a built-in inclination sensor. A user inclines or shakes the controller 30 to thereby input instructions. The controller 30 is configured to receive the instructions to the controller 30 by the user. The camera 31 is configured to take an image of the face of a user, who observes a pathological image by using the viewer computer 500.

The network 300 is connected to the network interface unit 28. The output unit 26 includes an image display apparatus such as a liquid crystal display, an EL (Electro Luminescence) display, or a plasma display. The output unit 26 includes a sound output apparatus such as a speaker or the like. The storage 27 is a magnetic disk such as an HDD (Hard Disk Drive), a semiconductor memory, an optical disk, or the like.

The CPU 21 expands a program corresponding to an instruction from the operation input unit 24, out of a plurality of programs stored in the ROM 22, the storage 27, and the like, in the RAM 23. The CPU 21 arbitrarily controls the output unit 26 and the storage 27 based on the expanded program.

The CPU 21 implements functional blocks (described later). The CPU 21 executes the programs stored in the ROM 22, the storage 27, and the like. The CPU 21 as necessary controls the above-mentioned units. Because of this, the viewer computer 500 is capable of implementing the various functional blocks. The viewer computer 500 is capable of causing the respective unit to function as the viewer computer 500.

[Configuration of Image Management Server 400]

Next, the hardware configuration of the image management server 400 will be described.

The hardware configuration of the image management server 400 is basically the same as the hardware configuration of the viewer computer 500 except that the controller 30 and the camera 31 are not connected to the interface unit 25. In view of this, detailed description of the hardware configuration of the digital pathological server 400 is omitted

[Functional Blocks of Image Management Server 400]

Next, the functional blocks of the image management server 400 will be described. The first main function of the image management server 400 is to provide a pathological image in response to a request from the viewer computer 500. The second main function of the image management server 400 is to store display history obtained from the viewer computer 500, and to provide the display history in response to a request from the viewer computer 500.

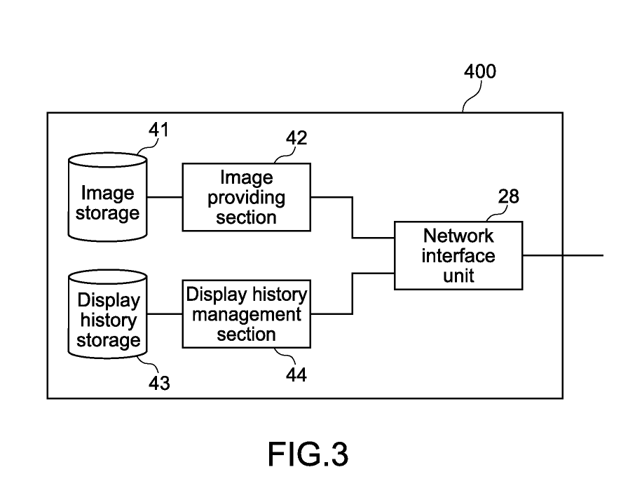

The third main function of the image management server 400 is to store comment (hereinafter, referred to as annotation), which a pathologist adds to a particular place of a pathological image by using the viewer. FIG. 3 is a diagram showing the functional blocks of the image management server 400.

The image management server 400 includes the following functional blocks, i.e., image storage 41, an image providing section 42, display history storage 43, and a display history management section 44.

The image storage 41 stores pathological images. The pathological image is divided into tiles, and JPEG compressed. The image providing section 42 provides the stored pathological images to the viewer computer 500 in response to a request from the viewer computer 500. Further, the image storage 41 also stores annotation, which a user adds to a pathological image by using the viewer of the viewer computer 500.

The viewer computer 500 sends an image request via the network 300. The image providing section 42 obtains pathological images, which correspond to the image request, from the image storage 41. The image providing section 42 sends the pathological images to the viewer computer 500 via the network 300.

The display history storage 43 stores display history of the viewer of the viewer computer 500, which is operated by a user.

The viewer computer 500 records and once collects display history. The display history management section 44 obtains the display history via the network 300. Further, the display history management section 44 stores the obtained display history in the display history storage 43. Further, the display history management section 44 receives a display history request from the viewer computer 500. The display history management section 44 obtains the display history from the display history storage 43 in response to the display history request. The display history management section 44 sends the display history to the viewer computer 500 via the network 300.

Note that the image management server 400 and the viewer computer 500 configure a client-server system. In this situation, functions that the client has and functions that the server has may be determined as necessary. In view of this, the image management server 400 does not necessarily execute the above-mentioned functional blocks. Alternatively, the viewer computer 500 as a client may execute the above-mentioned functional blocks.

[Functional Blocks of Viewer Computer 500]

Next, the functional blocks of the viewer computer 500 will be described. The first main function of the viewer computer 500 is to receive operational instructions from a pathologist as a user, to obtain an appropriate pathological image from the image management server 400, and to display the pathological image to a user. The second main function of the viewer computer 500 is to record a displayed image corresponding to viewer operations when a user performs image diagnosis, and to send the display history to the image management server 400 such that the image management server 400 stores the display history.

The third main function of the viewer computer 500 is to obtain display history stored in the image management server 400 in response to a request from a user, to reproduce a displayed image corresponding to an operation by a user based on the display history, and to show the image to the user.

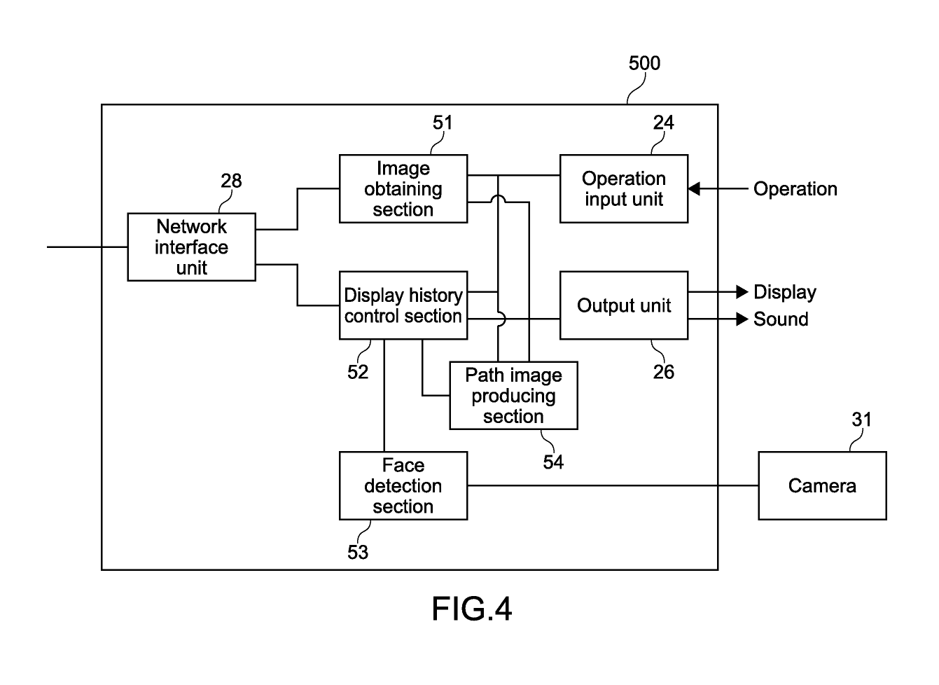

FIG. 4 is a diagram showing the functional blocks of the viewer computer 500.

The viewer computer 500 includes the following functional blocks, i.e., an image obtaining section 51 (obtaining section), a display history control section 52 (recording section, reproduction section), a face detection section 53 (detection section), and a path image producing section 54 (producing section).

The operation input unit 24 receives an instruction from a pathologist as a user, and inputs the instruction in the image obtaining section 51. The image obtaining section 51 obtains a pathological image, which corresponds to the instruction, from the image management server 400 via the network 300. The image obtaining section 51 presents the obtained pathological image to the user by using the output unit 26.

The display history control section 52 records, in response to an instruction from a user, change of window display based on viewer operations when a user observes a pathological image. First, the RAM 23 or the storage 27 of the viewer computer 500 stores recorded data. In response to a record stop instruction, the recorded data is collected. The collected data is sent to the image management server 400 as display history. The image management server 400 stores the display history.

Further, in response to an instruction from a user, the display history control section 52 obtains display history, which corresponds to the instruction, from the image management server 400. The display history control section 52 shows window display of the viewer, which is recorded in the obtained display history, to the user by means of the output unit 26.

Note that a user inputs an instruction to record/reproduce display history of the viewer window in the display history control section 52 by using a display record/reproduction GUI (described later).

Further, the display history control section 52 passes the following information to the path image producing section 54. The information includes a portion of a pathological image displayed on the viewer window, and a time period that the portion is displayed.

The face detection section 53 detects if the face of a pathologist, who observes a pathological image displayed on a display of the output unit 26 of the viewer computer 500, is in an image taken by the camera 31 or not. The camera 31 is connected to the face detection section 53 via the interface unit 25. The face detection section 53 may be configured, at the very least, to detect a face of a person. Alternatively, the face detection section 53 may be configured to distinguish a face and to identify an individual (facial recognition). As a matter of course, it is necessary to set the shooting direction and the focus position of the camera 31 at the position of the face of a pathologist, when the pathologist sits in front of the output unit 26 of the viewer computer 500 and observes an image on the display.

The path image producing section 54 obtains position information and time information from the display history control section 52. The position information is information on a portion of a pathological image, which is currently displayed. The time information is information on a time period during which the portion is displayed. The path image producing section 54 decreases transparency of pixels of a mask image. How to decrease transparency will be described later in detail.

[Viewer Window]

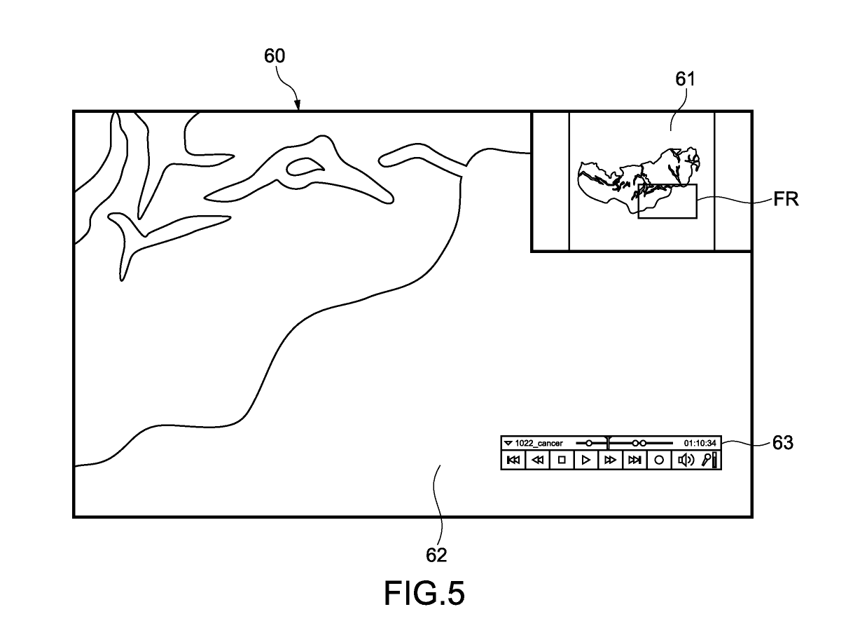

Next, a viewer window will be described. A user uses the viewer window to observe a pathological image by using the viewer computer 500. FIG. 5 is a diagram showing an example of the viewer window.

A viewer window 60 includes a thumbnail map 61, an observation area 62, and a display record/reproduction GUI 63. The thumbnail map 61 shows a zoom-in portion of a pathological image. The observation area 62 is used to observe a pathological image. The thumbnail map 61 includes a reduced-size image of the entire virtual slide image, and a frame FR. The frame FR equivalently shows the area of the image, which is displayed on the viewer window 60, in the thumbnail map 61.

In response to an instruction from a user, the frame FR may be moved on the thumbnail map 61 in an arbitrary direction and by an arbitrary amount. Note that a frame movement operation may be input by dragging a mouse or the like on the thumbnail map 61.

The display record/reproduction GUI 63 receives a recording start instruction or a recording stop instruction of change of a display window corresponding to a viewer operation input from a user. The display record/reproduction GUI 63 transmits the received instruction to the display history control section 52. The display record/reproduction GUI 63 will be described later in detail.

[Display Record/Reproduction GUI]

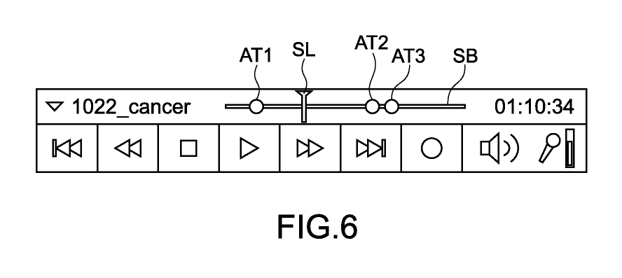

Next, the display record/reproduction GUI 63 will be described. FIG. 6 is a diagram showing an example of the display record/reproduction GUI.

In FIG. 6, the file name of display history is displayed on the upper left portion of the display record/reproduction GUI 63. A seek bar SB is displayed on the upper middle portion, and extends in the lateral direction. A slider SL and circles AT1, AT2, and AT3 are displayed on the seek bar SB. The slider SL shows the position being reproduced. Each of the circles AT1, AT2, and AT3 shows the time on which an annotation is added.

An elapsed time in a case of recording or reproducing change of display on the viewer window is displayed on the upper right portion. Note that the elapsed time and in addition the entire time period required for reproduction may be displayed in the case of reproduction. When recording, for example, a record button may light up on the display record/reproduction GUI 63, to thereby display that display history is being recorded. In addition, an elapsed time of recording is displayed on the display record/reproduction GUI 63.

Further, in FIG. 6, rewind, stop, reproduce, fast-forward, and record buttons are displayed on the lower portion of the display record/reproduction GUI 63. A volume button and a microphone button are displayed on the lower right portion.

In this example, the circles AT1, AT2, and AT3 are displayed on the seek bar SB. Each of the circles AT1, AT2, and AT3 shows the time on which an annotation is added. Because of this, when a user drags the slider to change the reproduction position, he may search for an annotation, which he wishes to see, easily.

[Recording/Reproducing Flow of Viewer Window Display]

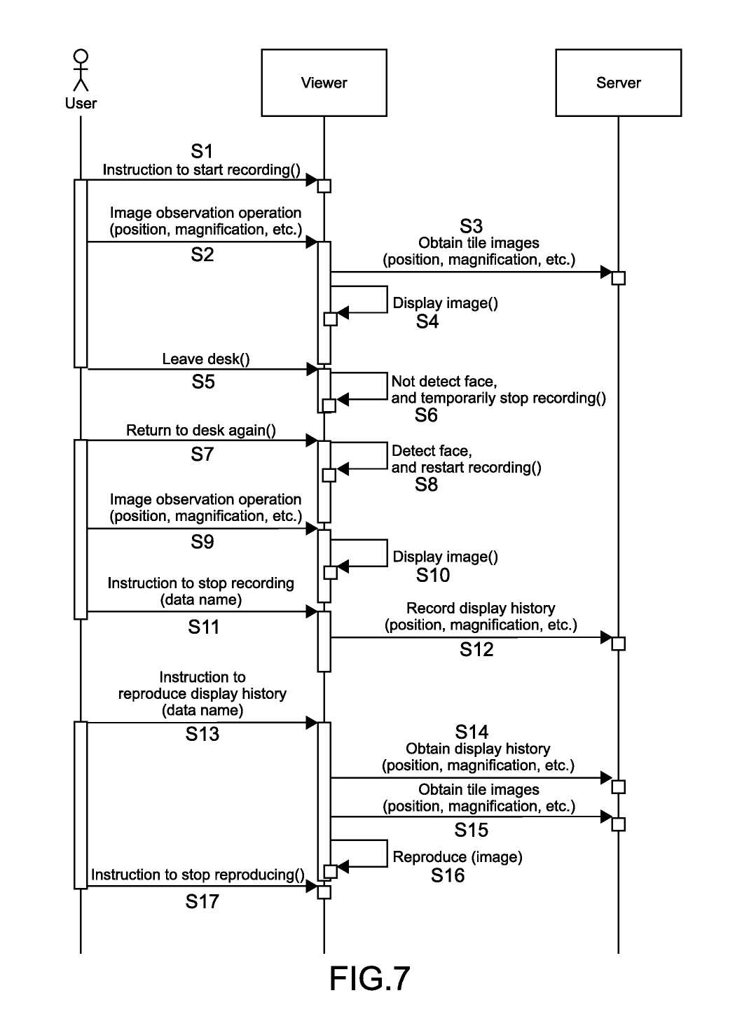

Next, recording/reproducing flow of window display history in response to viewer operations, and processing flow when a user leaves his desk will be described. FIG. 7 is a sequence diagram for explaining the recording/reproducing flow of window display history in response to viewer operations, and the processing flow when a user leaves his desk.

First, the flow of recording display history will be described.

First, a user clicks the record button of the display record/reproduction GUI 63, to thereby instruct the display history control section 52 to start to record viewer display (S1). After that, a user selects a pathological image to be observed from a list of pathological images, which is displayed on the viewer.

After the display history control section 52 receives the instruction to start recording, the face detection section 53 searches for the face of a user who observes the viewer window. During this time, the display history control section 52 periodically records change of window display, which a user inputs in the viewer (S2). Specifically, the change of window display includes change of a display position, and change of observation magnification.

A user changes a display position, or changes observation magnification. In this case, the image obtaining section 51 requests the image management server 400 to obtain the corresponding tile images (S3).

The image obtaining section 51 obtains the images from the image management server 400. The images are displayed on the window (S4).

When a user leaves his desk (S5), the face detection section 53 is not capable of detecting the face of the user. So the face detection section 53 transmits information that the face is not detected to the display history control section 52. The display history control section 52 receives the information that the face is not detected from the face detection section 53. Then, the display history control section 52 temporarily stops recording change of window display (S6).

When the user returns to his desk and has a seat again (S7), the camera 31 takes a picture of the user's face. The face detection section 53 detects the user's face again. The face detection section 53 transmits information that the face is detected to the display history control section 52. The display history control section 52 receives the information that the face is detected from the face detection section 53. Then, the display history control section 52 restarts to record change of window display (S8).

The user continues to operate the viewer window (S9). The image obtaining section 51 displays the pathological image on the viewer window (S10). During this time, the display history control section 52 continues to record display status on a window as display history.

The user clicks the stop button of the display record/reproduction GUI 63, to thereby instruct the display history control section 52 to stop recording viewer display (S11). At this time, a name is assigned to the recorded display history. When receiving the stop instruction, the display history control section 52 sends the display history, which the display history control section 52 stores locally and temporarily, to the image management server 400 (S12). The display history management section 44 stores the received display history in the display history storage 43.

The flow of recording display history has been described above. Next, the flow of reproducing display history will be described.

First, a user specifies the name of display history to be reproduced. In addition, the user clicks the reproduce button of the display record/reproduction GUI 63, to thereby instruct the display history control section 52 to reproduce display history (S13).

When the instruction to reproduce display history is input, the display history control section 52 requests the display history management section 44 of the image management server 400 to obtain the display history, which is specified by the user. The display history control section 52 obtains the display history from the image management server 400 (S14).

Further, when the instruction to reproduce display history is input, the image obtaining section 51 obtains images to be displayed when reproducing the display history, from the image storage 41 of the image management server 400 (S15).

By using the obtained display history and images, display is reproduced on the viewer window (S16). Finally, the user clicks the stop button of the display record/reproduction GUI 63, to thereby instruct the display history control section 52 to stop reproducing display history (S17). Then, the display history control section 52 stops reproducing the display history.

The flow of reproducing display history has been described above.

[Format of Display History]

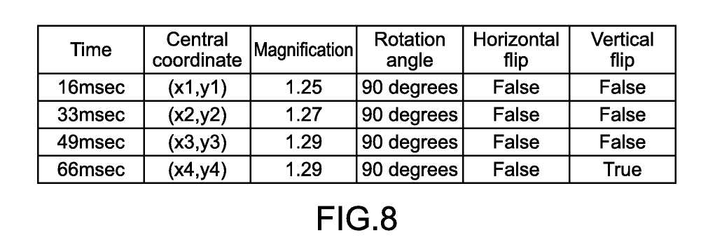

Next, a recording format will be described. The recording format is used when the display history control section 52 records display history. FIG. 8 is a diagram showing an example of the format of display history. In this example, six items, i.e., “time”, “central coordinate”, “magnification”, “rotation angle”, “horizontal flip”, and “vertical flip”, are recorded.

What each item means will be described. First, “time” shows an elapsed time (millisecond) after the display history control section 52 starts recording display history. In this example, display history is recorded every 1/60 seconds, i.e., about 16 msec. As a result, the values of FIG. 8 are recorded. Here, the example employs 1/60 seconds because of the following reason. That is, when reproducing display history, a moving image of 60 fps (frames per second) is reproduced based on the actual time. Because of this, data of each item of the display history is recorded for each frame.

Next, “central coordinate” shows the following information. A portion (partial image) of the entire image (pathological image) is displayed in the observation area 62 of the viewer window. “Central coordinate” shows the coordinate of the center point of the partial image in the entire image in this case.

“Magnification” is observation magnification in a case of displaying a partial image in the observation area 62. In this example, 1.25-fold observation magnification at first increases to 1.29-fold observation magnification after 66 msec passes after recording is started.

Further, “rotation angle” is a rotation angle of a partial image when the partial image is displayed in the observation area 62. “Horizontal flip” and “vertical flip” show if the partial image is flipped in the horizontal direction and in the vertical direction or not, respectively, by using the value “True” or “False”.

An example of recording basic items has been described above. In addition, for example, items “face detection” and “annotation” may be added. The item “face detection” has the value “True” or “False”. “True” means that the face detection section 53 detects a user's face at a time when display history is recorded. “False” means that the face detection section 53 fails to detect a user's face.

In the above-mentioned recording/reproducing flow, the display history control section 52 temporarily stops recording when a face is not detected. In other words, if the display history control section 52 records change of window display, a face is certainly detected. Alternatively, let's say that the display history control section 52 continues to record change of window display even if a face is not detected. In this case, the item “face detection” may be used. For example, if a face is detected when reproducing display history, the mark “eye” may be displayed on the screen. For example, if a face is not detected, the mark “x” may be displayed on the mark “eye” on the screen.

The item “annotation” has the value “True” at a time when a user adds an annotation on a pathological image.

[Recording of Display Path with Gradation Display]

Next, a specific example of an independent function of the viewer computer 500 of the present technology will be described. The independent function is the following function. That is, a path of a displayed partial image is recorded as a color gradation path image depending on the length of a time period, during which the partial image is displayed in the observation area 62. The path image producing section 54 executes this function. Note that this function may be executed in parallel with the above-mentioned display history recording function, may be executed as a different function, or may be executed based on the recorded display history.

Note that this function may be realized as follows. That is, a mask image is superimposed on a pathological image (entire image) by using an alpha value as a coefficient by means of alpha blending, to thereby produce a composite path image. The pathological image (entire image) will be referred to as “entire pathological image”. The mask image records a display path. A display path is recorded as follows. That is, a time period, during which the area of a partial image is displayed in the observation area 62, is measured. The longer the display time period, the larger the alpha value of the color of a path showing the area.

[Alpha Value and Alpha Blending]

Next, how to produce a path image will be described in detail. First, an alpha value and alpha blending will be described. The alpha value and the alpha blending are used when a mask image is superimposed on an entire pathological image displayed on the thumbnail map 61, to thereby show a display path.

The alpha value is transparency information, which is set for each pixel of digital image data processed by a computer. Further, the alpha blending is to superimpose one image on another image to thereby produce a composite image by using a coefficient (alpha value). According to the present technology, the one image is a mask image, and the other image is an entire pathological image on the thumbnail map 61. The mask image is superimposed on the entire pathological image.

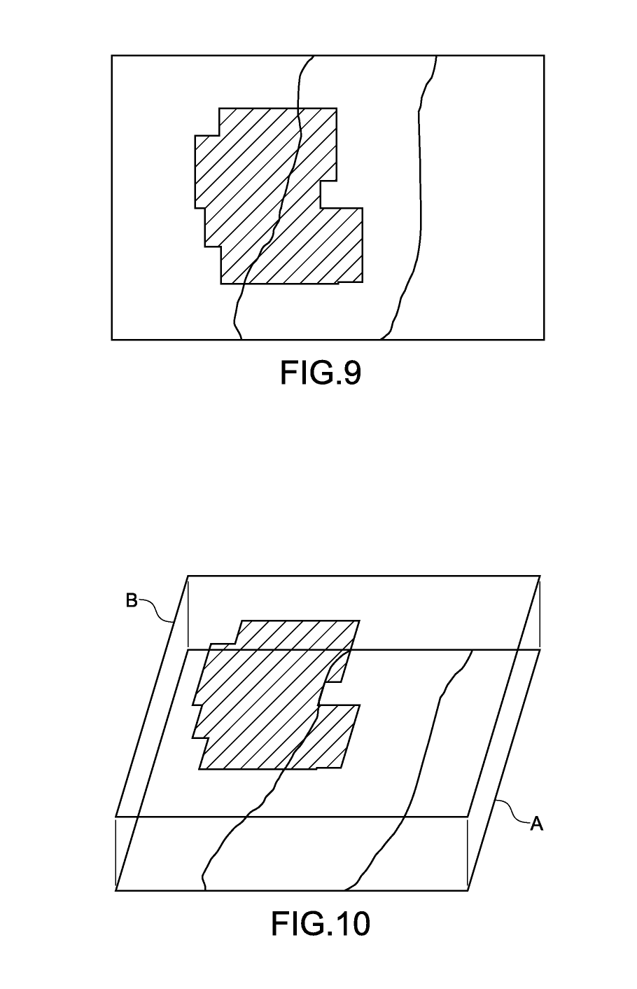

FIG. 9 is a diagram showing a composite path image, in which a display path is superimposed on an entire pathological image. FIG. 10 is a diagram showing that an entire pathological image A and a mask image B are different images, and that the mask image B is superimposed on the pathological image A.

As shown in FIG. 9 and FIG. 10, an entire pathological image and a mask image are different images. The path image producing section 54 adjusts the alpha value, which shows transparency of a mask image. The path image producing section 54 records a display path on the mask image. Further, after that, the mask image, of which alpha value is adjusted, is superimposed on the entire pathological image by means of alpha blending, to thereby produce a composite path image.

The alpha value is, for example, an integer value between 0 and 255. If the alpha value of a pixel is 0, the pixel of a mask image is transparent perfectly. In this case, a pixel of the entire pathological image, which is behind the pixel of the mask image, is seen through perfectly. If the alpha value is about 128, a pixel of a mask image is translucent and colored (for example, green). In this case, the color of a pixel of the entire pathological image, which is behind the pixel of the mask image, is seen through by half. If the alpha value is 255, a pixel of a mask image is opaque perfectly. In this case, the color of a pixel of the entire pathological image, which is behind the pixel of the mask image, is not seen through at all.

According to the present technology, the transparency of a mask image is perfect transparency at first. The alpha value is increased and the transparency of a mask image is decreased depending on a display time period in the observation area 62, whereby the mask image is colored. In this manner, a display path is recorded. Alternatively, to the contrary, a display path may be recorded in the following manner. That is, the transparency of a mask image is about 70% at first. The alpha value is decreased and the transparency of a mask image is increased depending on a display time period in the observation area 62, whereby the color of the mask image is faded away.

Note that a mask image and an entire pathological image are different images. Because of this, if all the alpha values of a mask image are reset to zero, recording of a path may be reset.

[Addition Method of Alpha Value (Basic Method)]

Let's say that at least a portion of a pathological image is displayed in the observation area 62. In this case, according to the present technology, for example, redrawing is repeated by using a frame rate of 60 fps to thereby display an image as if it is a moving image. The same applies to the thumbnail map 61. In view of the above, for example, let's say that a specific area of a pathological image is displayed in the observation area 62 for a predetermined time period. In this case, the alpha value may be increased by one for each frame. As a result, after a time period (1 second) corresponding to 60 frames passes, the alpha value of pixels of a mask image, which corresponds to the position displayed on the observation area, reaches 60. As a result, opacity of the mask image is increased by about 23%.

If a display time period exceeds four seconds, the alpha value reaches 255, and the mask image is perfectly opaque. In this case, a user is not capable of seeing the entire pathological image, which is behind the mask image. So it is difficult for the user to know an observed portion of a pathological image based on comparison between the shape of the entire pathological image and a display path. In view of the above, the alpha value may have an upper limit. For example, let's say that the upper limit of an increased alpha value is 180. In this case, the alpha value is not increased any more after transparency reaches about 70%. As a result, a user is capable of always seeing an entire pathological image, which is behind a mask image.

Note that, in this example, an alpha value is increased by one for each frame. Alternatively, an alpha value may be increased by one for every 30 seconds, for example. In this case, it takes 90 minutes until the alpha value reaches the upper limit, i.e., 180. As a result, even in a case of recording observation for a longer time period, transparency may be different depending on time, and a display path may be recorded appropriately. Anyway, the increase rate of an alpha value may be determined depending on a typical observation time period.

[Addition Method of Alpha Value (in Consideration of Observation Magnification)]

In the above-mentioned configuration, an alpha value is increased unconditionally in a case where a specific area of a pathological image is displayed in the observation area 62 for a predetermined time period. Alternatively, the increase rate of an alpha value may be changed depending on observation magnification in observing a pathological image. Let's say that a deeper color (higher opacity of mask image) of a path of a path image shows that a user observes a pathological image in more detail. In this case, higher opacity may show that an observation time period of one portion is longer. Similarly, higher observation magnification means that a user observes an image in more detail. So, in this case, the increase rate of an alpha value may be increased.

For example, if the observation magnification is less than twofold, the increase amount of an alpha value for each time unit is 0, and a path is not recorded. If the observation magnification is twofold or more and less than fourfold, the increase amount of an alpha value for each time unit is 1. If the observation magnification is fourfold or more, the increase amount of an alpha value for each time unit is 2. According to this configuration, it is possible to record a display path in consideration of observation magnification.

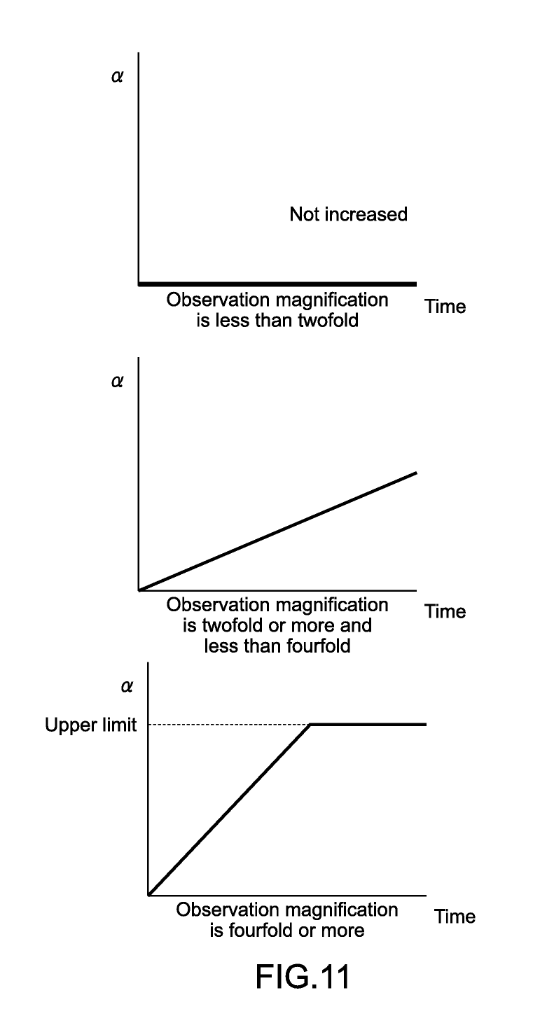

FIG. 11 shows graphs each showing how an alpha value is increased in this example. As shown in the upper graph, if the observation magnification is less than twofold, the alpha value is always zero and is not increased even if time passes. If the observation magnification is twofold or more and less than fourfold, the alpha value is gradually increased. If the observation magnification is fourfold or more, as described above, the observation magnification is rapidly increased until it reaches the upper limit, but is not increased after that.

[Addition Method of Alpha Value (in Consideration of Observation Time)]

In the above-mentioned configuration, in a case where a specific portion is observed for a predetermined time period, an alpha value is increased monotonically. However, if a specific portion is observed for a longer time period, then it means that the portion is observed in more detail. In this case, it is desirable to increase the increase rate of an alpha value.

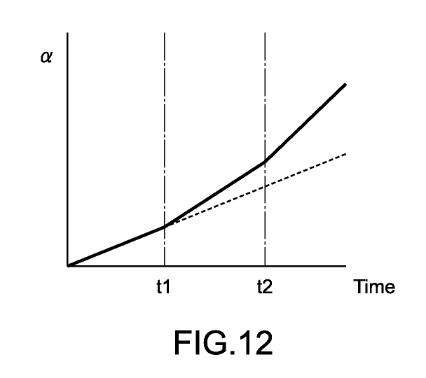

FIG. 12 is a graph showing how the increase amount of an alpha value is changed in a case where a specific portion is observed for a long time period. For example, the alpha value is increased by n for each time unit after a specific portion is displayed in the observation area 62 and a user starts to observe the portion and until the time t1 elapses. After the time t1 elapses, the increase amount of an alpha value is increased by 1.1-fold, and the increase amount is 1.1n for each time unit.

Further, if the same portion is observed for a predetermined time period and the time t2 elapses, the increase amount of an alpha value is increased by 1.2-fold, and the increase amount is 1.2n for each time unit. The value n is changed depending on observation magnification, as described above. If an image displayed in the observation area 62 is moved, n is used as the initial increase amount of an alpha value again.

According to this configuration, if a specific portion is observed for a longer time period, the path may be highlighted and recorded.

[Flow of Producing Path Image]

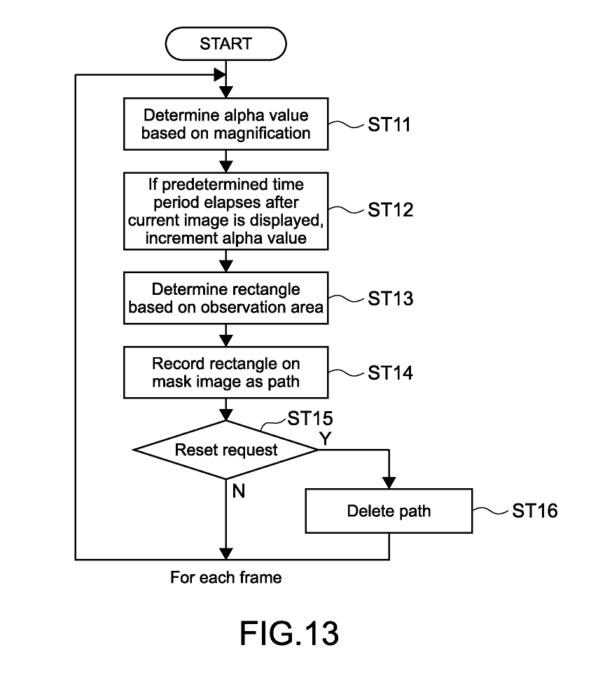

Next, the processing flow of producing a path image by the path image producing section 54 will be described. FIG. 13 is a flowchart for explaining a processing flow of producing a path image. Note that, as described above, a path image is updated for each frame (for example, every 1/60 seconds in a case of 60 fps). Similarly, the flowchart is processed for each frame.

First, the path image producing section 54 determines an alpha value based on the current observation magnification (Step ST11).

Next, the path image producing section 54 determines if a predetermined time period elapses or not after the current image is displayed in the observation area 62. If a predetermined time period elapses, the path image producing section 54 increments the alpha value (Step ST12).

Next, the path image producing section 54 determines a rectangular area based on the area of the image displayed in the observation area 62 (Step ST13). The alpha value of a mask image of the rectangular area will be changed.

Next, the path image producing section 54 records a rectangle on the mask image as a path (Step ST14). Here, the increase amount of an alpha value is added to the alpha value of target pixels in the mask image. The increase amount of an alpha value is determined in Step ST11 or ST12. As a result, the path image producing section 54 records a rectangle. After the path image producing section 54 records a rectangle, the rectangle, which has the color of a mask image, is displayed on the entire pathological image on the thumbnail map 61. The rectangle shows the area of the observation area 62.

Here, the path image producing section 54 determines if a display path reset request from the operation input unit 24 is input or not. If the reset request is input (Step ST15, Y) the path image producing section 54 deletes all the paths on the thumbnail map 61 (Step ST16).

The path image producing section 54 deletes a path by resetting alpha values of all the pixels of a mask image to an initial value.

The processing flow of producing a path image by the path image producing section 54 has been described above.

[Practical Example of Path Image]

Hereinafter, first, an example of allocation of time when a user observes a pathological image will be described. Color gradation of a displayed path corresponding to the observation will be described.

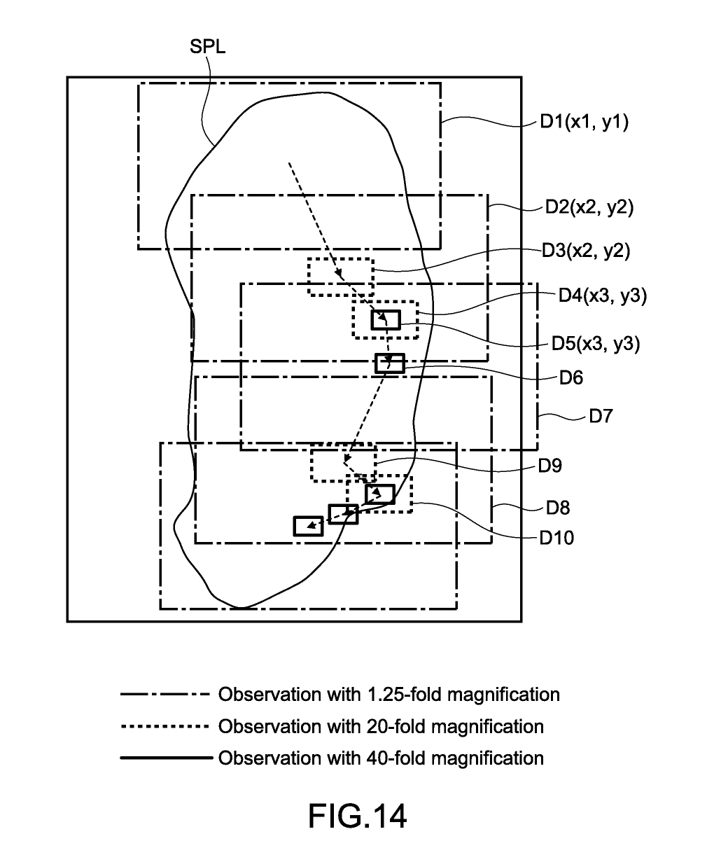

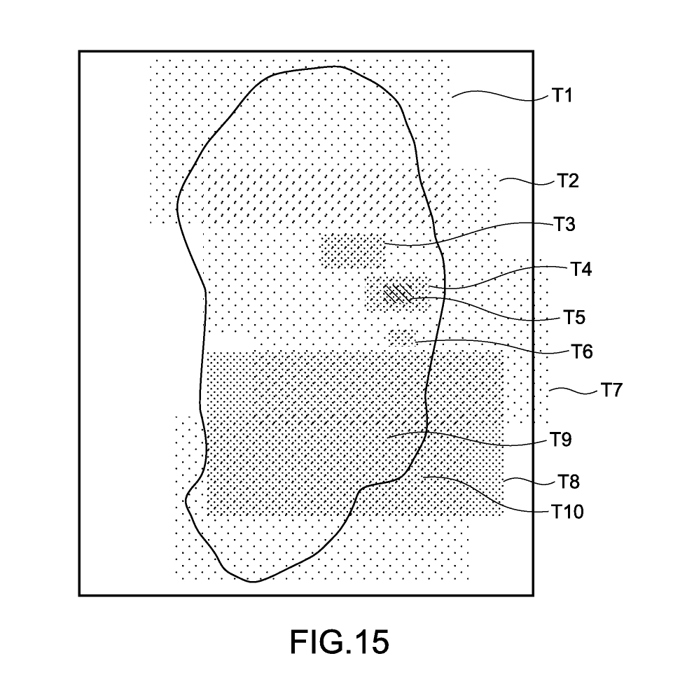

FIG. 14 is a diagram showing a process that a user browses a shot image of a sample SPL displayed in the observation area 62. FIG. 15 is a diagram showing an example in which the display process is recorded as a display path.

With reference to FIG. 14, operation by a user and how a pathological image is displayed in the observation area 62 will be described.

First, operated by a user, the upper area D1 of the sample SPL, as a partial image, is displayed with 1.25-fold observation magnification in the observation area 62.

The user observes the partial image for 8 seconds. Note that the central coordinate of the display area D1 is (x1, y1).

Next, the user changes the display area of the partial image from D1 to D2. The user observes the partial image for 20 seconds. The central coordinate of the display area D2 of the partial image is (x2, y2).

Next, operated by the user, the observation magnification is rescaled from 1.25-fold to 20-fold, and the display area D3 of the partial image is thus displayed. The user observes the partial image for 35 seconds. At this time, the central coordinate of the partial image is not changed, and is still (x2, y2).

Next, operated by the user, the display area D3 of the partial image is moved to the display area D4. The user observes the partial image for 40 seconds. The central coordinate of the partial image is (x3, y3).

Next, operated by the user, the observation magnification is rescaled from 20-fold to 40-fold, and the display area D5 of the partial image is thus displayed. The user observes the partial image for 2 minutes. At this time, the central coordinate of the partial image is not changed, and is still (x3, y3).

After that, the user observes partial images in the same manner. Areas D3, D4, and D6 are displayed for 30 seconds or more and less than 1 minute. Further, an area D8 is displayed for 1 minute or more and less than 2 minutes. Further, an area D5 is displayed for 2 minutes or more.

Next, with reference to FIG. 15, an example of recording a display path in the above-mentioned observation process will be described.

The display areas D1 and D2 are observed for less than 30 seconds. Paths T1 and T2 correspond to the display areas D1 and D2, respectively. The paths T1 and T2 are recorded in the palest color. Meanwhile, the display areas D3, D4, and D6 are observed for 30 seconds or more. Paths T3, T4, and T6 correspond to the display areas D3, D4, and D6, respectively. The paths T3, T4, and T6 are shown in the color deeper than the color of the path T1.

Similarly, a path T8 is shown in the deeper color. A path T5 is shown in the deepest color.

As described above, the display history control section 52 measures a time period, during which a partial image is displayed in the observation area 62. The display history control section 52 shows a path of a display area by using color gradation. As a result, the display history control section 52 is capable of easily showing a time period, for which a user observes a specific portion. It is possible to accurately record a path when a pathologist makes a diagnosis by using an image. As a result, a pathological image may not be passed over.

[Time Measurement and Taking Snapshot]

Next, another function of the display history control section 52 will be described. This function is the following function. That is, the display history control section 52 takes a snapshot of a partial image depending on a time period, during which the partial image is displayed in the observation area 62. This function is executed in parallel with the above-mentioned display history recording function.

A time period, during which a specific partial image is displayed on the observation area 62, exceeds 3 minutes, for example. In this case, the display history control section 52 takes a snapshot of the partial image. A snapshot is taken by means of screen copy, for example. A snapshot is taken because of the following reason. If one partial image is displayed for a long time period, then it means that what the image shows is important, and that a user as an observer observes the image carefully for a long time period.

Let's say that a user leaves his desk after a specific partial image is displayed. A display time period of this case is also long. In the past, this case is not distinguished from the case where a user observes an image for a long time period. However, according to the present technology, the camera 31 detects a user. Because of this, the former case may be distinguished from the latter case.

[Time Measurement and Screensaver Operation]

Next, another function of the display history control section 52 will be described. This function is the following function. That is, the display history control section 52 issues a warning depending on a time period, during which a user's face is not detected when the viewer is used. Further, the display history control section 52 locks a window by using a screensaver. The function is executed in combination with the above-mentioned display history recording function.

When a user uses the viewer, a first predetermined time period (for example, 5 minutes) elapses after the face detection section 53 fails to detect the user's face. Then, the display history control section 52 issues a warning to the user. The warning is, for example, a warning alarm. Further, a second predetermined time period (for example, 10 minutes) elapses after the face detection section 53 fails to detect the user's face. Then, the display history control section 52 locks the viewer window. For example, the display history control section 52 starts a screensaver with a password, to thereby lock the viewer window.

After the face detection section 53 fails to detect the user's face, the display history control section 52 executes two-step operation. This is based on the following reason. If the face detection section 53 fails to detect a user's face, then it may not mean that the user leaves his desk, but it may mean that the user merely turns his head away. However, if a predetermined time period elapses, there is a high possibility that the user leaves his desk. In this case, the display history control section 52 locks the viewer window. In this manner, the state of a user is determined, and it is possible to automatically protect a pathological image including personal information.

[Flow of Behaviors of Respective Functions]

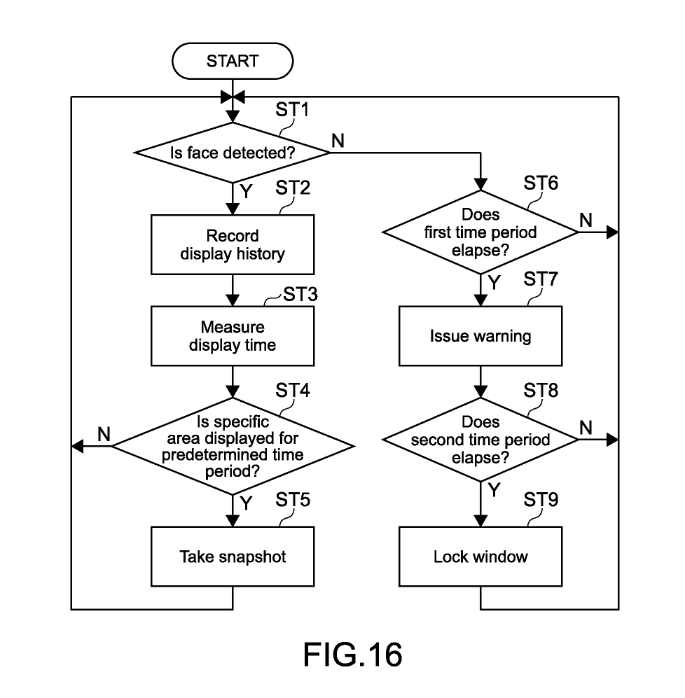

Here, the relation of the above-mentioned functions in the overall processing flow will be described. FIG. 16 is a flowchart for explaining the relation of the functions of the present technology in the overall processing flow.

First, a user sits in front of the viewer computer 500. The camera 31 starts to take a picture of the user's face. Then, the face detection section 53 detects the user's face (Step ST1, Y).

Next, the display history control section 52 records display history (Step ST2). The display history is the display status in the observation area 62, which is changed based on a viewer operation input by a user.

Next, the display history control section 52 measures a time period, during which one partial image is displayed on the observation area 62 (Step ST3). The measurement result obtained here is used as an index of executing the above-mentioned functions. In addition, the measurement result is stored in the image management server 400 as attribute information of a pathological image. The measurement result as attribute information is a time period, during which a user actually watches a pathological image and makes a diagnosis. The display history control section 52 measures a time period, only if the face detection section 53 detects a face. Because of this, an accurate diagnosis time period may be measured.

One partial image is displayed in the observation area 62 for a predetermined time period or more (for example, more than 3 minutes), and the user observes the partial image (Step ST4, Y). In this case, the display history control section 52 takes a snapshot of the partial image, which is displayed in the observation area 62 (Step ST5). The processes of Steps ST2 to ST5 are repeated while the face detection section 53 keeps on detecting the user's face after the user inputs an instruction to record display history.

Meanwhile, the camera 31 fails to take a picture of a user's face, and the face detection section 53 fails to detect a user's face (Step ST1, N). In this case, if the first time period (for example, 5 minutes) elapses (Step ST6, Y), the display history control section 52 issues a warning to a user (Step ST7).

Next, a face is still not detected and the second time period (for example, 10 minutes) elapses (Step ST8, Y). In this case, the display history control section 52 locks the viewer window (Step ST9).

The overall processing flow including the above-mentioned functions has been described above.

[Configuration in Place of Camera 31 and Face Detection Section 53]

According to the above-mentioned configuration, the camera 31 and the face detection section are used to detect a user, who observes a pathological image by using the viewer computer 500. However, the configuration is not limited to this as long as it is capable of detecting the presence of a user.

For example, a physical switch may be provided on a desk. When a user keeps on pressing the switch, display history is recorded. Alternatively, a physical switch may be a toggle switch. In this case, if the switch is once turned on, display history is recorded even if a user does not press the switch. Alternatively, a toggle switch may be a software switch. In this case, it is possible to reduce the cost of a physical switch.

[Other Configuration of the Present Technology]

Note that the present technology may employ the following configurations.

(1) An information processing apparatus, comprising:

an obtaining section configured to obtain a pathological image;

a display unit configured to display at least a portion of the obtained pathological image as partial display area;

an input unit configured to receive an instruction to move the partial display area from a user;

a recording section configured to periodically record at least position information of the partial display area in the pathological image as display history, the position information being in relation with display time; and

a reproduction section configured to reproduce movement of the partial display area in the pathological image based on the pathological image and the display history.

(2) The information processing apparatus according to (1), wherein

the reproduction section is configured to reproduce the movement of the partial display area in the pathological image based on time corresponding to actual time.

(3) The information processing apparatus according to (1) or (2), further comprising:

a detection section configured to detect presence of a user, the user observing a pathological image, wherein

the recording section is configured to periodically record at least position information of the partial display area in the pathological image as display history while the detection section keeps on detecting the presence of the user, the position information being in relation with display time.

(4) The information processing apparatus according to (3), wherein

the detection section includes
a camera configured to take a picture of the face of the user, and
a face detection section configured to detect if the camera takes a picture of the face or not, and

the recording section is configured to periodically record at least position information of the partial display area in the pathological image as display history while the face detection section keeps on detecting the face, the position information being in relation with display time.

(5) The information processing apparatus according to any one of (1) to (4), wherein

the recording section is further configured to record, if a display time period of a specific area exceeds a preset time period, an image of the specific area, the specific area being in an area displayed as the partial display area.

(6) The information processing apparatus according to any one of (1) to (5), further comprising:

a producing section configured
to produce images to be superimposed on all the pixel sites of the displayed partial display area, respectively, at a predetermined time cycle, each of the to-be-superimposed images having a value corresponding to a display time period of the partial display area,
to cumulatively superimpose the to-be-superimposed images on the pathological image, and
to produce a composite result as a path image, the path image showing a movement path of an area displayed as the partial display area.
   (7) An information processing method, comprising:

obtaining, by an obtaining section, a pathological image;

displaying, by a display unit, at least a portion of the obtained pathological image as partial display area;

receiving, by an input unit, an instruction to move the partial display area from a user;

periodically recording, by a recording section, at least position information of the partial display area in the pathological image as display history, the position information being in relation with display time; and

reproducing, by a reproduction section, movement of the partial display area in the pathological image based on the pathological image and the display history.

(8) An information processing program, causing a computer to function as:

an obtaining section configured to obtain a pathological image;

a display unit configured to display at least a portion of the obtained pathological image as partial display area;

an input unit configured to receive an instruction to move the partial display area from a user;

a recording section configured to periodically record at least position information of the partial display area in the pathological image as display history, the position information being in relation with display time; and

a reproduction section configured to reproduce movement of the partial display area in the pathological image based on the pathological image and the display history.

[Supplementary Note]

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2012-157241 filed in the Japan Patent Office on Jul. 13, 2012, the entire content of which is hereby incorporated by reference.

What is claimed is:

1. An information processing apparatus, comprising:
an obtaining section configured to obtain a pathological image;
a display unit configured to display at least a portion of the obtained pathological image as partial display area;
an input unit configured to receive an instruction to move the partial display area from a user;
a recording section configured to periodically record at least position information of the partial display area in the pathological image as display history, the position information being in relation with display time; and
a reproduction section configured to reproduce movement of the partial display area in the pathological image based on the pathological image and the display history.

2. The information processing apparatus according to claim 1, wherein
the reproduction section is configured to reproduce the movement of the partial display area in the pathological image based on time corresponding to actual time.

3. The information processing apparatus according to claim 2, further comprising:
a detection section configured to detect presence of a user, the user observing a pathological image, wherein
the recording section is configured to periodically record at least position information of the partial display area in the pathological image as display history while the detection section keeps on detecting the presence of the user, the position information being in relation with display time.

4. The information processing apparatus according to claim 3, wherein
the detection section includes
a camera configured to take a picture of the face of the user, and
a face detection section configured to detect if the camera takes a picture of the face or not, and
the recording section is configured to periodically record at least position information of the partial display area in the pathological image as display history while the face detection section keeps on detecting the face, the position information being in relation with display time.

5. The information processing apparatus according to claim 4, wherein
the recording section is further configured to record, if a display time period of a specific area exceeds a preset time period, an image of the specific area, the specific area being in an area displayed as the partial display area.

6. The information processing apparatus according to claim 1, further comprising:
a producing section configured
to produce images to be superimposed on all the pixel sites of the displayed partial display area, respectively, at a predetermined time cycle, each of the to-be-superimposed images having a value corresponding to a display time period of the partial display area,
to cumulatively superimpose the to-be-superimposed images on the pathological image, and
to produce a composite result as a path image, the path image showing a movement path of an area displayed as the partial display area.

7. An information processing method, comprising:
obtaining, by an obtaining section, a pathological image;
displaying, by a display unit, at least a portion of the obtained pathological image as partial display area;
receiving, by an input unit, an instruction to move the partial display area from a user;
periodically recording, by a recording section, at least position information of the partial display area in the pathological image as display history, the position information being in relation with display time; and
reproducing, by a reproduction section, movement of the partial display area in the pathological image based on the pathological image and the display history.

8. An information processing program, causing a computer to function as:
an obtaining section configured to obtain a pathological image;
a display unit configured to display at least a portion of the obtained pathological image as partial display area;
an input unit configured to receive an instruction to move the partial display area from a user;
a recording section configured to periodically record at least position information of the partial display area in the pathological image as display history, the position information being in relation with display time; and
a reproduction section configured to reproduce movement of the partial display area in the pathological image based on the pathological image and the display history.
